(19) United States
(12) Patent Application Publication
(10) Pub. No.: US 2013/0268218 A1
(43) Pub. Date: Oct. 10, 2013

(54) TESTING SYSTEM AND METHOD

(71) Applicant: CAI-JIN YUAN, Shenzhen City (CN)

(72) Inventor: CAI-JIN YUAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/479,306

(22) Filed: May 24, 2012

(30) Foreign Application Priority Data
Apr. 6, 2012 (CN) 201210098778.1

(51) Int. Cl. G06F 19/00

(52) U.S. Cl. 702/60

(57) ABSTRACT

A testing method implemented by a testing system connected to an device includes generating a power on control signal according to preset test parameters and sending to the single chip; controlling a relay to power on the device according to the power on control signal; testing whether the device is successfully powered on; testing whether information of the device is successfully read out during the powering on of the device; testing whether the device is successfully powering off when the device is successfully powered on and the information is successfully read out, ending testing when the device is not successfully powered on and/or the information is not successfully read out, and recording a test result. A testing system is also provided.

### BACKGROUND

1. Technical Field

The present disclosure relates to testing systems and testing methods, and more particularly, to a testing system and a testing method for testing powering on/off.

2. Description of Related Art

A conventional testing method usually includes setting parameters such as time interval on a relay, transmitting power to the storage device via the relay, reading information of the storage device by another computer software (such as Putty or Hyper-terminate), and displaying the testing information. However, all disks in the storage device may not be completely detected each time when testing powering on/off of the storage device in the time interval, furthermore, as the relay is not connected with the computer, the numbers of powering on/off the storage device displayed on the computer may not be consistent with actual numbers performed by the relay, which resulting in a lot of time spent to determine whether the computer or the relay has problems, and affecting the reliability of the testing.

### BRIEF DESCRIPTION OF THE DRAWINGS

Many aspects of the present embodiments can be better understood with reference to the drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of a testing system, in accordance with the present disclosure.

FIG. 2 is a block diagram of an embodiment of a computer in the testing system of FIG. 1, in accordance with the present disclosure.

FIG. 3 is a flowchart of an embodiment of a testing method implemented by the testing system in FIG. 1, in accordance with the present disclosure.

### DETAILED DESCRIPTION

Embodiments of the present disclosure will be described with reference to the accompanying drawings.

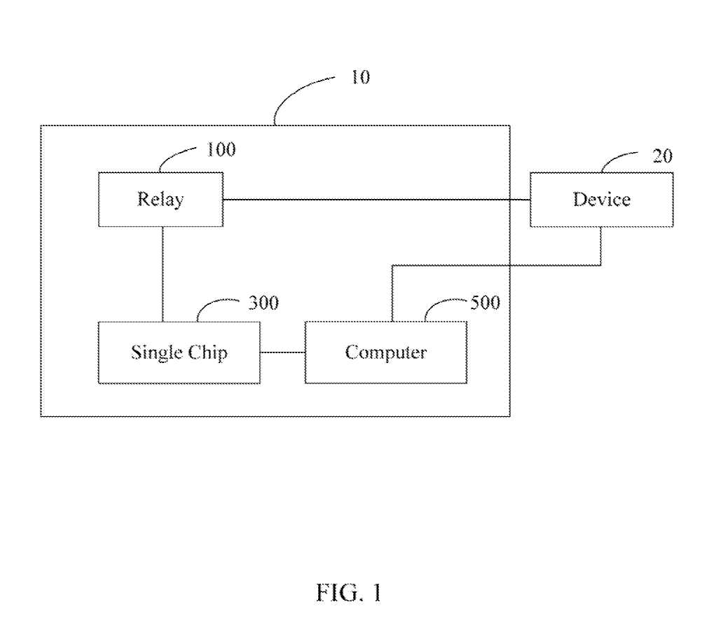

FIG. 1 is a block diagram of an embodiment of a testing system, in accordance with the present disclosure. The testing system 10 is connected to a device 20, to test powering on/off of the device 20. The device 20 may be a storage device, such as SAS JBOD (Just a Bunch Of Disks), FC JBOD, or a server. A storage device will be described as an example to explain. The testing system 10 can run on a computer. The testing system 10 includes a relay 100, a single chip 300 (single-chip processor), and a computer 500. The relay 100 is connected with the storage device 20, to power on/off the storage device 20. The single chip 300 is connected with the relay 100 and the computer 500, to receive a power on and power off control signal from the computer 500, control the relay 100 to power on the storage device 20 according to the power on control signal and power off the storage device 20 according to the power off control signal.

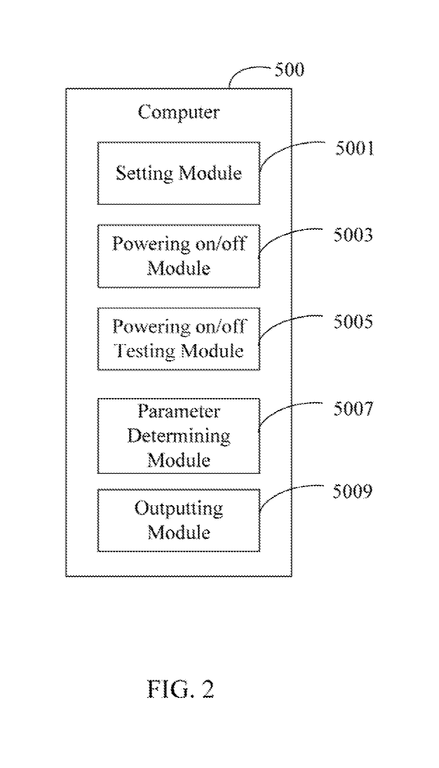

The computer 500 is connected with the storage device 20 via a HBA (Host Bus Adapter) card. The HBA card is used to read information of the storage device 20, such as numbers of the disks in the storage device 20, configuration, and running results indicating whether each of the disk can be read, for example. A software is run on the computer 500 to implement the test system 10. See FIG. 2, the computer 500 includes a setting module 5001, a powering on/off module 5003, a powering on/off testing module 110, a parameter determining module 5007, and an outputting module 5009.

The setting module 5001 is used to set test parameters from a user after the testing system 10 is connected to the storage device 20. The test parameters include numbers of testing whether the storage device 20 is successfully powered on and off, and/or a time interval from testing whether the storage device 20 is successfully powered on to testing whether the storage device 20 is successfully powered off, for example, the numbers of testing whether the storage device 20 is successfully powered on and off can be set to perform 500 times, and the time interval may be 1 minute.

The powering on/off module 5003 generates the power on/off control signal according to the pre-set test parameters and sends the power on/off control signal to the single chip 300.

The powering on/off testing module 5005 tests whether the storage device 20 is successfully powered on, whether information of the storage device 20 is successfully read out during the powering on of the storage device 20. The powering on/off testing module 5005 further tests whether the storage device 20 is successfully powered off when the storage device 20 is successfully powered on, ends testing when the storage device 20 is not successfully powered on, and records a test result. The test result indicates whether the storage device 20 is successfully powered on and/or off each time and in the time interval, whether the information of the storage device 20 is successfully read out, for example.

The parameter determining module 5007 determines whether actual numbers of testing whether the storage device 20 is successfully powered on and off reaches the preset numbers of testing whether the storage device 20 is successfully powered on and off. The parameter determining module 5007 may include a counter, which could automatically accumulate one each time the storage device 20 is successfully powered on and off, and compare the accumulated numbers with the preset numbers of testing whether the storage device 20 is successfully powered on and off, to determine whether the accumulated numbers reaches the preset numbers.

The outputting module 150 outputs the test result, by printing or displaying, for example.

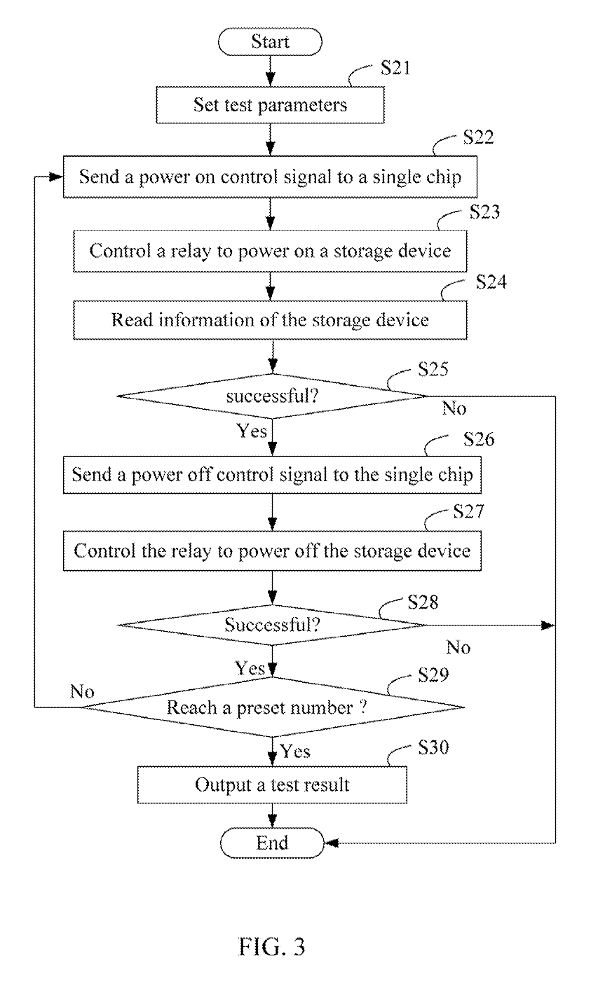

FIG. 3 is a flowchart of an embodiment of testing method implemented by the testing system in FIG. 1, in accordance with the present disclosure.

In step S21, the setting module sets test parameters after the testing system 10 is connected to the storage device 20.

In step S22, the powering on/off module 5003 generates the power on control signal and sends the power on control signal to the single chip 300.

In step S23, the single chip 300 controls the relay 100 to power on the storage device 20 after receiving the power on control signal.

In step S24, the powering on/off testing module 5005 controls the HBA card to read information of the storage device 20.

In step S25, the powering on/off testing module 5005 tests whether the storage device 20 is successfully powered on, whether information of the storage device 20 is successfully read out during the powering on of the storage device 20. If yes, the procedure goes to step S26, if no, the procedure ends.

In step S26, the powering on/off module 5003 generates the power off control signal and sends the power off control signal to the single chip 300.

In step S27, the single chip 300 controls the relay 100 to power off the storage device 20 after receiving the power off control signal.

In step S28, the powering on/off testing module 5005 tests whether the storage device 20 is successfully powering off, and records the test result. If yes, the procedure goes to step S29, if no, the procedure ends.

In step S29, the parameter determining module 5007 determines if the actual number of testing whether the storage device 20 is successfully powered on and off reaches the preset number of testing whether the storage device 20 is successfully powered on and off. If yes, the procedure goes to step S30, if no, the procedure goes to the step S22.

In step S30, the outputting module 150 outputs the test result, and then the procedure ends.

Though above system and method, the testing system and method control the relay 100 by the computer 500 to power on/off of the storage device 20, to test only when the information of the of the storage device 20 is successfully read out, therefore, the numbers of testing whether the storage device 20 is successfully powered on and off displayed on the computer 500 are consistent with actual numbers performed by the relay 100, which enables the reliability of the testing.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A testing system for being connected to a device, the testing system comprising:
a relay, connected with the device to power on/off the device;
a computer, connected with the device, to generate a power on control signal and power off control signal according to preset test parameters and send the power on/off control signals to the single chip;
a single chip, connected with the relay and the computer, to receive the power on control signal and power off control signal from the computer, control the relay to power on the device according to the power on control signal and power off the device according to the power off control signal;
wherein the computer is further operable to test whether the device is successfully powered on, whether information of the device is successfully read out during the powering on of the device, test whether the device is successfully powering off when the device is successfully powered on and the information is successfully read out, end testing when the device is not successfully powered on and/or the information is not successfully read out, and record a test result.

2. The testing system of claim 1, wherein the testing system is run on a computer.

3. The testing system of claim 1, wherein the device is a storage device of SAS JBOD (Just a Bunch Of Disks) or FC JBOD, or a server.

4. The testing system of claim 3, wherein when the device is a storage device, the computer is connected with the storage device via a HBA (Host Bus Adapter) card, the HBA card is used to read information of the storage device.

5. The testing system of claim 4, wherein the information of the storage device is numbers of the disks in the storage device, configuration, and whether each of the disk can be read out.

6. The testing system of claim 1, wherein the computer is further used to set test parameters from a user after the testing system is connected to the device.

7. The testing system of claim 1, wherein the test result comprises whether the storage device is successfully powered on and off each time and in the time interval, and whether the information of the device is successfully and completely read out.

8. The testing system of claim 1, wherein the test parameters comprises numbers of testing whether the device is successfully powered on and off, and/or a time interval from the powering on to the powering off of the device.

9. The testing system of claim 8, wherein the computer is further used to determine if an actual number of testing whether the device is successfully powered on and off reaches to the preset number of testing whether the device is successfully powered on and off.

10. The testing system of claim 1, wherein the computer is further used to output the recorded test result.

11. A testing method implemented by a testing system connected to an device, the testing method comprising:
generating a power on control signal according to preset test parameters and sending to the single chip;
controlling a relay to power on the device according to the power on control signal;
testing whether the device is successfully powered on;
testing whether information of the device is successfully read out during the powering on of the device;
testing whether the device is successfully powering off when the device is successfully powered on and the information is successfully read out, ending testing when the device is not successfully powered on and/or the information is not successfully read out, and
recording a test result.

12. The testing method of claim 10, wherein the testing method is run on a computer.

13. The testing method of claim 10, wherein the device is a storage device of SAS JBOD (Just a Bunch Of Disks) or FC JBOD, or a server.

14. The testing method of claim 13, wherein when the device is a storage device, the method further comprising reading information of the storage device via a HBA (Host Bus Adapter) card.

15. The testing method of claim 14, wherein the information of the storage device is numbers of the disks in the storage device, configuration, and whether each of the disk can be read out.

16. The testing method of claim 10, comprising setting test parameters from a user after the testing system is connected to the device.

17. The testing method of claim 10, wherein the test result comprises whether the storage device is successfully powered on and/or off each time and in the time interval, and whether the information of the device is successfully read out.

18. The testing method of claim 10, wherein the test parameters comprises numbers of testing whether the device is successfully powered on and off, and/or a time interval from the powering on to the powering off of the device.

19. The testing method of claim 18, comprising determining if an actual number of testing whether the device is successfully powered on and off reaches to the preset number of testing whether the device is successfully powered on and off.

20. The testing method of claim 10, comprising outputting the recorded test result.
